(19) United States
(12) Patent Application Publication
(10) Pub. No.: US 2005/0068418 A1
(43) Pub. Date: Mar. 31, 2005

(54) Calibration jig for a stereoscopic camera and calibrating method for the camera

(75) Inventors: Masaaki Kaneko, Tokyo (JP); Kenichi Hayami, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/942,804

(22) Filed: Sep. 17, 2004

(30) Foreign Application Priority Data
Sep. 30, 2003 (JP) 2003-340120

(51) Int. Cl. H04N 17/00

(52) U.S. Cl. 348/187

(57) ABSTRACT

The present invention has as its object the provision of a jig for carrying out, in a position recognizing a subject having cameras for photographing a subject from a plurality of directions, the position calibration or the like of these cameras. The jig is disposed as a jig for calibration near the photographing center in the plurality of cameras, and is comprised of a portion for fixing and supporting, for example, a true sphere in which the centers found from photographed images obtained by the cameras for photographing the jig spatially coincide with one another.

### BACKGROUND OF THE INVENTION

1. Field of the Invention

This invention relates to a jig used to calibrate, for a so-called stereoscopic camera, i.e., cameras disposed correspondingly to individual directions to photograph a subject from a plurality of directions, the photographing positions of these individual cameras, and a calibrating method for these cameras.

2. Related Background Art

For example, in the process of mounting a chip-shaped electronic part on a circuit board, in order to recognize the held positions of the electronic part and the circuit board, respective ones of them held at a reference position are photographed by discrete cameras or the like, and the correction of the positional deviation of the individual ones is effected from the comparison between the respective photographed images. At that time, unless the positional relation between the photographing centers or the like of the individual cameras is grasped in advance, it becomes impossible to compare a plurality of photographed images with one another.

In the usage of effecting the positioning of a subject by the use of such image recognition, it will suffice if position recognition on XY plane, i.e., two dimensions, can be done. Accordingly, the cameras, even if the coordinates of the arrangement thereof on XY plane may in some cases differ, are disposed toward opposed directions or the same direction. The alignment of the photographing fields of view of the thus disposed cameras is usually effected as follows.

When for example, the cameras are disposed so as to be opposed to each other, as is exemplarily shown in Japanese Patent Application Laid-Open No. 7-162200, a mark printed on a transparent substrate is photographed by each of the opposed cameras, and the positional relation (the center of the field of view) between the cameras is found from the individual photographed images to thereby effect the correction thereof. Also, when the cameras are disposed in the same direction, as is exemplarily shown in Japanese Patent Application Laid-Open No. 2000-258121 or Japanese Patent Application Laid-Open No. 2000-502447, a group of recognition marks having a predetermined position relation are formed in advance on a plane, and these are successively photographed by individual cameras having passed through a predetermined, operation to thereby find the positional relation (the center of the field of image) between the individual cameras and effect the correction thereof.

With the downsizing and higher performance of electronic apparatuses, circuit boards contained therein are also downsized, and chips mounted on the circuit boards or the intervals among the individual chips have also become small. Therefore, it becomes necessary to grasp and avoid, for example, the surrounding chips or the bumps thereof, or the vertices or the like of the unevenness of bumps on the circuit boards, and there is conceivable a case when it becomes difficult to obtain an appropriate mounted state by the positioning hitherto used. That is, there is the possibility of causing the necessity of taking into account the shape of the chips which has heretofore posed no problem, specifically unevenness or the like produced by end portion electrodes, and determine the mounted position thereof when the chips are mounted on the circuit board. In this case, it is impossible to accurately grasp the shape or the like of the chips by only the cameras comprising a conventional construction and installed in the same or opposed directions. Accordingly, it is necessary to newly dispose a camera for photographing a subject from a direction differing from that in the prior art.

The thus newly installed camera, when used to merely grasp the shape of a subject, seems to be usable even if the center of the field of view thereof is not so strictly prescribed. However, when it is required to actually recognize the shape or the like of the subject, it is necessary to strictly prescribe the center of the field of view and obtain the correlation thereof with the centers of the fields of view of the other cameras. In this case, a jig or the like heretofore used premises the alignment on a plane to the last, and it is impossible to use it intactly.

### SUMMARY OF THE INVENTION

The present invention has been made in view of the above-noted situation and has as its object the provision of a jig used to calibrate for respective camera disposed correspondingly to individual directions to photograph a subject from a plurality of directions, the photographing position of the individual cameras, and a calibrating method for these cameras.

In order to solve the above-noted problems, a jig for calibrating the photographing positions of cameras according to the present invention is a jig used to calibrate, for cameras disposed correspondingly to individual directions to photograph a subject from a plurality of directions, the photographing positional of the individual cameras, and is characterized by a portion which can be fixed substantially centrally of a photographing field of view in the plurality of cameras, and has a shape in which the central portions of respective images photographed by the plurality of cameras coincide with one another. This portion constitutes the essential portion of the jig according to the present invention, as a subject to be photographed by the plurality of cameras.

It is preferable that the specific shape of the above-described jig be one of a sphere, a regular polyhedron and a rectangular parallelepiped. Also, it is preferable that the jig be fixed and supported by a substance capable of transmitting light therethrough. Or the jig may be photographed by the plurality of cameras and be supported by a supporting member at a position which does not vary information obtained from the photographed images in the operation of finding the central portion of each of the photographed images. Or the jig may be formed of a magnetic material and be fixed and supported by magnetism. In the jig, in preparation for a case where for example, an inconvenience occurs to a main subject to be photographed, a preliminary subject to be photographed as a dummy may be added in advance.

Also, when the jig is fixed by the use of the substance capable of transmitting light therethrough, it is required to consider the refractive index of the substance. That is, it becomes necessary to count in the refractive index of the substance during image analysis, or determine the shape of the substance so that image pickup from a surface perpendicular to the optical axis of the camera on which the influence of the refractive index becomes smallest can be effected.

Also, in order to solve the above-noted problem, a calibrating method for a camera according to the present invention is a method of carrying out the position calibration of a plurality of cameras in a system for recognizing the position of a subject on the basis of a plurality of photographed images obtained by photographing a subject from different directions by the plurality of cameras, and is characterized by the step of photographing a three-dimensional jig fixed substantially at the center of a photographing field of view in the plurality of cameras by the plurality of cameras, the step of the central portion of each of the photographed images of the three-dimensional jig obtained by the plurality of cameras, the step of finding the amount of deviation between the central portion of the photographed image by each of the plurality of cameras and the photographing field of view, and the step of correcting the photographed images by the plurality of cameras on the basis of the amount of deviation. This correcting step may be carried out by driving the cameras themselves, or may be carried out by correcting photographed image data.

In the above-described calibrating method, it is preferable that the jig be a sphere. Or it is preferable that the jig be a polyhedron which has a plurality of planes substantially perpendicular to the photographing optical axes of the plurality of cameras, and in which a perpendicular passing through the center of each of the plurality of planes coincides with the center of gravity.

According to the present invention, there is found the center of the photographed image of the jig obtained by photographing the jig disposed at the center of the photographing field of view in the plurality of cameras by each camera. When for example, the jig is a sphere, the photographed image thereof obtained by each of the plurality of cameras is a circle and the center thereof always coincides with the center of the jig which is a sphere. Accordingly, by finding the amount of deviation between the center of the circle photographed by each camera and the center of the photographing field of view, it is possible to find the amount of deviation between the center of the photographing field of view of each camera and the spatial center to be photographed by the plurality of cameras. By carrying out the calibration of the positions of the cameras or the photographed image on the basis of this amount of deviation, it becomes possible to accurately grasp the spatial disposition of a subject to be photographed.

If the shape of the jig is such that the centers of the photographed images thereof obtained by the respective cameras spatially coincide with one another, it is possible to perform each of the above-described operations. Accordingly, in conformity with the camera disposed, for example, a regular polyhedron, a rectangular parallelepiped or the like can be used as the jig. These shapes can be easily made into a construction which has a plurality of planes substantially perpendicular to the photographing optical axes of the plurality of cameras, and in which a perpendicular passing through the center of each of the plurality of planes coincides with the center of gravity, and it is possible to easily make the centers of the plurality of photographed images spatially coincident with one another. Also, it is desirable that these shapes or the like be suitably selected in conformity with the shape, posture, disposition, etc. of a subject actually photographed and recognized by the cameras.

Also, as a method of fixing the jig, the specific method thereof is not particularly restricted if it is a method which, when the center of the photographed image of the jig is to be found, does not affect the operation. For example, by supporting the jig by a transparent material such as resin, glass or water, it becomes possible to easily photograph only the image of the jig, and the best effect is obtained. Also, a similar effect will be obtained even if for example, the jig is formed of a magnetic material and also, a suitable magnetic force is made to act on the jig, or the floating state of the jig is maintained by a gas. Or use may be made of very thin piano wire or a bar-shaped supporting member, and when the center of the photographed image is to be found, the supporting member may be made to act on a position having no influence, for example, in a case where the jig is a regular polyhedron, a surface on which the cameras are not disposed.

The jig according to the present invention constructed above is simple in its construction and can also be constructed with the size, weight, etc. thereof suppressed. Accordingly, it is easy to add this jig to an existing inspecting apparatus or the like, and there can be obtained the effect that the calibrating accuracy of the individual cameras, and particularly the camera for photographing a subject from sideways or the like, can be markedly improved.

According to the present invention, for the cameras disposed correspondingly to individual directions to photograph a subject from a plurality of directions, a single jig is photographed, whereby it becomes possible to easily and simply calibrate the disposition or the photographing positions of the individual cameras. The jig used in the present invention is simple in its construction and therefore, it is also easy to add it to an inspecting apparatus or the like for effecting the confirmation of the position of a subject by the use of a plurality of cameras.

### BRIEF DESCRIPTION OF THE DRAWINGS

FIG. 1 illustrates a calibrating jig according to a first embodiment of the present invention and the positional relation of cameras, etc. during the use thereof.

FIG. 2 illustrates a calibration jig according to a second embodiment of the present invention and the positional relation of cameras, etc. during the use thereof.

FIG. 3A shows an example of a shape usable as the center of the jig.

FIG. 3B shows an example of a shape usable as the center of the jig.

FIG. 4 shows another example of a construction for supporting the center of the jig.

FIG. 5 shows another example of the construction for supporting the center of the jig.

### DESCRIPTION OF THE PREFERRED EMBODIMENTS

### First Embodiment

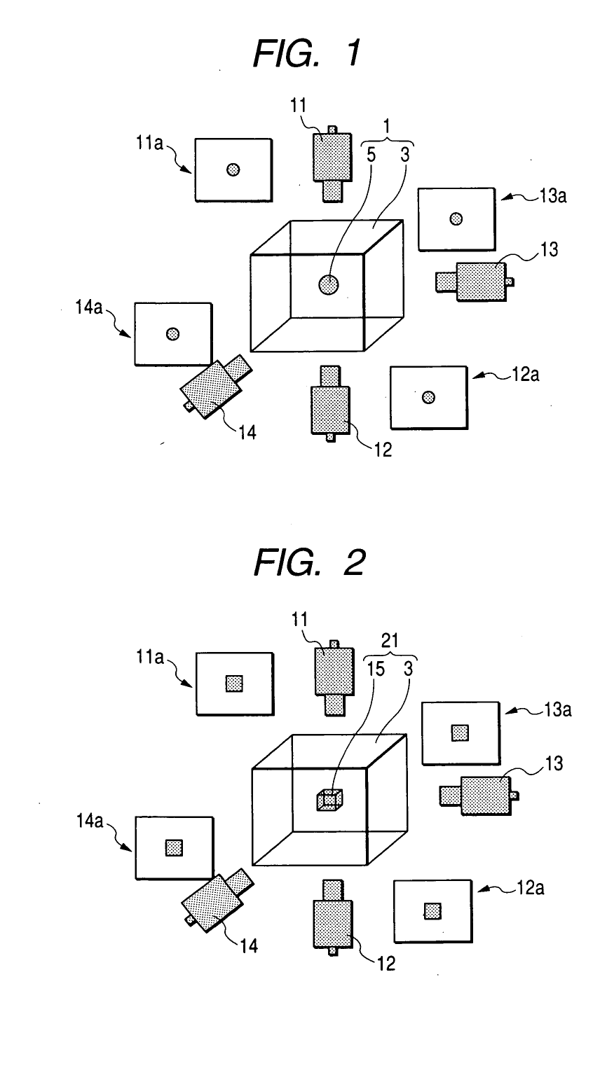

FIG. 1 schematically shows a jig according to a first embodiment of the present invention, and a case where the position calibration of a plurality of (in this case, four) cameras is effected by the use thereof. In the present embodiment, there are shown the essential portions of a calibrating method in a photographing system for photographing a subject from above, below, the front of and the side of it. This photographing system is comprised of an upper camera 11, a lower camera 12, a front camera 13 and a side camera 14. The jig 1 according to the present embodiment is comprised of a true sphere 5 which is the center of the jig formed, for example, of iron which is low in the transmittance for light, and a transparent acryl resin portion 3 for fixing and supporting it substantially at the center, and is installed at a position which is substantially the center of each of the photographing fields of view of these cameras.

When the jig is photographed by the individual cameras, the obtained photographed images are an image 11a, an image 12a, an image 13a and an image 14a correspondingly to the upper camera 11, the lower camera 12, the front camera 13 and the side camera 14, respectively. The acryl resin portion 3 transmits light therethrough and therefore, actually is not photographed as a photographed image, but only the true sphere 5 which is the center of the jig is photographed as a photographed image. The true sphere, if seen from any direction, is a circular shape as shown in FIG. 1, and the center thereof can be easily grasped. Also, the centers of a plurality of circular images obtained coincide with the center (the center of gravity) of the true sphere 5. Accordingly, by finding the positional deviation between the center of the photographing field of view of each individual camera and the center of this circular shape, it is possible to effect the position calibration or the construction of the photographing fields of view of the individual cameras.

In the present embodiment, the true sphere 5 is fixed and supported by acryl resin. However, the construction for fixing the true sphere 5 in the jig according to the present invention is not restricted to this acryl resin, but may be glass or the like which is high in the transmittance for light. Also, as shown, for example, in FIG. 4, it is possible to support the true sphere 5 by a bar-shaped supporting member 7 comprising piano wire or the like. Thus, it is also possible to fix and support the true sphere 5 by any member of a shape which, when for example, regarding the photographed image of the true sphere, the center of the circular shape is to be found in the photographed images obtained by the plurality of cameras, is photographed only as such a degree of image as may not affect the processing.

### Second Embodiment

FIG. 2 shows a jig according to a second embodiment of the present invention, and a case where the position calibration of a plurality of (in this case, four) cameras is effected by the use thereof. A camera system in the present embodiment is the same as that described in the first embodiment and therefore, the portions thereof are given the same reference characters as those in FIG. 1 and need not be described here. In the present embodiment, use is made of a jig 21 in which the true sphere 5 which is the center of the jig in FIG. 1 is replaced by a regular hexahedron (a cube) 15. The regular hexahedron 15, when disposed so that the individual surfaces thereof may be substantially perpendicular to the photographing optical axes of a plurality of cameras, easily makes a perpendicular passing through the center of each of a plurality of planes coincident with the center of gravity, and it is possible to easily make the centers of a plurality of photographed images spatially coincident with one another. Accordingly, there is obtained an effect similar to that of the first embodiment.

Again in the present embodiment, it is possible to support the regular hexahedron 15 by a bar-shaped supporting member 7 comprising piano wire or the like, as shown, for example, in FIG. 5. In this case, for example, the photographed image of the supporting member 7 is easy to neglect in image processing for the photographed image of the regular hexahedron 15, and for example, it is possible to connect the supporting member to the back side on which no camera is disposed to thereby support it. Also, as the supporting member 7, use can be made of any member of a shape which, when the center of the regular hexahedron is to be found in each of photographed images obtained by the plurality of cameras, is photographed only as such a degree of image as does not affect the processing.

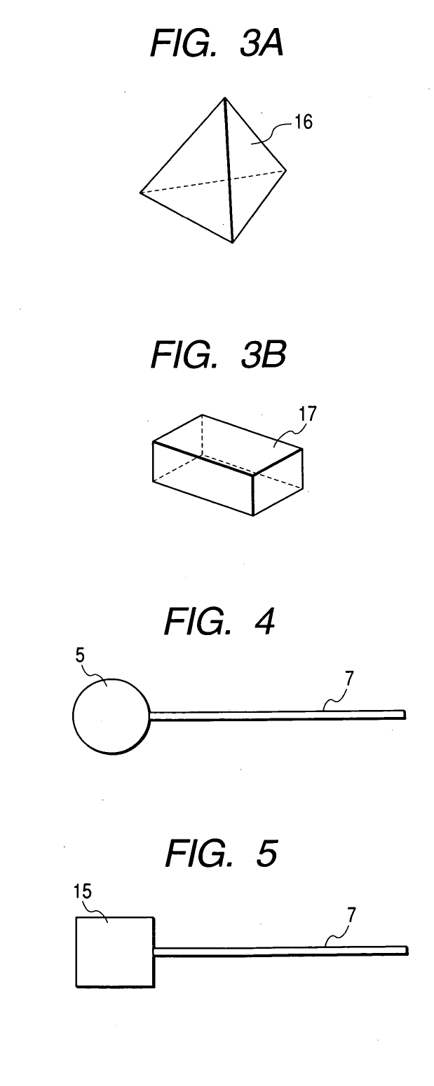

While in the second embodiment, there has been shown by way of example a case where the regular hexahedron 15 is used as the center of the jig 1, the present embodiment is not restricted to this shape. That is, any shape in which it is easy to find the central portions of photographed images obtained by the individual cameras, and the centers of the photographed images recognized by the plurality of cameras spatially coincide with one another can be used as the center of the jig of the present invention. Specifically, it is possible to use such a shape as a regular polyhedron such as a regular tetrahedron 16 shown in FIG. 3A, or a rectangular parallelepiped 17 shown in FIG. 3B.

The number and disposition of the cameras are suitably selected depending on a subject to be photographed, and for example, in the case of a construction in which cameras photograph a subject from any three directions, besides the above-described regular hexahedron, the regular tetrahedron 16 shown in FIG. 3A is used as the center of the jig and the cameras are disposed on the directions passing through the center of gravity thereof and being perpendiculars to the respective surfaces, whereby there is obtained the effect described in the first embodiment or the second embodiment. Likewise, when the number of the cameras is increased, it is also possible to cope with it by using a regular polyhedron in which the relation between the center of gravity and respective surfaces thereof is a relation similar to that of the center tetrahedron or the regular hexahedron. Also, the rectangular parallelepiped 17 shown in FIG. 3B in which the relation between the center of gravity and respective surfaces thereof is a relation similar to that of the regular tetrahedron or the regular hexahedron can also be used as the center of the jig.

As previously described, the calibration jig according to the present invention and the calibrating method using this jig can be applied in an apparatus for photographing a subject from two or more different directions and recognizing the position thereof when the calibration of cameras or the like used in the photographing is effected.

This application claims priority from Japanese Patent Application No. 2003-340120 filed Sep. 30, 2003, which is hereby incorporated by reference herein.

1. A jig used to calibrate, for cameras disposed corresponding to individual directions to photograph a subject from a plurality of directions, the photographing position of each of said cameras, having:
a portion fixable substantially centrally of a photographing field of view in said plurality of cameras, and comprising a shape in which the central portions of photographed images photographed by said plurality of cameras coincide with one another.

2. A jig according to claim 1, where in said shape is one of a sphere, a regular polyhedron and a rectangular parallelepiped.

3. A jig according to claim 1 or 2, wherein said jig is fixed and supported by a substance capable of transmitting light therethrough.

4. A jig according to claim 1 or 2, wherein said jig is photographed by said plurality of cameras and is supported by a supporting member at a position which does not vary information obtained from the photographed images thereof in an operation of finding the central portion of each of said photographed images.

5. A jig according to claim 1 or 2, which is formed of a magnetic material, and is fixed and supported by magnetism.

6. A method of carrying out the position calibration of a plurality of cameras in a system for recognizing the position of a subject on the basis of a plurality of photographed images obtained by photographing said subject by a plurality of cameras from different directions, having:
a step of photographing a three-dimensional jig fixed substantially centrally of a photographing field of view in said plurality of cameras by said plurality of cameras;
a step of finding the central portion of each of the photographed images of said three-dimensional jig obtained by said plurality of cameras;
a step of finding an amount of deviation between said central portion of the photographed image by each of said plurality of cameras and said photographing field of view; and
a step of correcting the photographed images by said plurality of cameras on the basis of said amount of deviation.

7. A calibrating method according to claim 6, wherein said jig is a sphere.

8. A calibrating method according to claim 6, wherein said jig is a polyhedron which has a plurality of planes substantially perpendicular to the photographing optical axes of said plurality of cameras and in which a perpendicular passing through the center of each of said plurality of planes coincides with a center of gravity.
